(19) United States
(12) Patent Application Publication
(10) Pub. No.: US 2016/0102841 A1
(43) Pub. Date: Apr. 14, 2016

(54) SILVER BASED REFLECTOR WITH HYBRID PROTECTION LAYERS

(71) Applicant: GE Lighting Solutions, East Cleveland, OH (US)

(72) Inventors: Dengke Cai, Willoughby, OH (US); Mark J. Mayer, Sagamore Hills, OH (US); Koushik Saha, Brunswick, OH (US); Tianji Zhao, Highland Heights, OH (US)

(21) Appl. No.: 14/510,504

(22) Filed: Oct. 9, 2014

(51) Int. Cl. F21V 7/22; F21V 13/04

(52) U.S. Cl. CPC F21V 7/22; F21V 13/04

(57) ABSTRACT

A silver-based reflector includes a hybrid protection layer that includes a thin Aluminum (Al) protection layer thermally deposited onto a Silver (Ag) reflective layer, which prevents yellowing or tarnishing of the Ag reflective layer. In an embodiment, a lamp reflector is formed by providing a substrate material in the shape of a reflector, thermally depositing an Ag reflective layer onto the an interior surface of the reflector having a sufficient thickness to reflect light, and thermally depositing an Al protective layer onto the Ag reflective layer to protect the Ag reflective layer from oxidation and sulfide formation. The Al protective layer has a thickness within the range of about 30 angstroms (Å) to about 100 Å.

### FIELD OF THE INVENTION

Embodiments of the present invention generally relate to lamps having a silver-based reflector that includes a hybrid protection layer. In an embodiment a thin Aluminum (Al) protection layer is deposited onto a Silver (Ag) reflective layer during fabrication to prevent yellowing or tarnishing of the Ag reflective layer.

### BACKGROUND OF THE INVENTION

Reflector lamps are widely used for applications such as interior and exterior spot lighting, automobile head lamps, and the like. Examples of typical reflector lamps include General Electric's PAR 38 and PAR 64 lamps. PAR is the commonly accepted acronym for “parabolic aluminized reflector.”

One of the most commonly used reflector coatings is aluminum (Al) film, which is typically deposited on the surface of a reflector by thermal evaporation and/or by use of a sputtering process. Manufacturing costs are low and the Al film is stable at lamp operating temperatures over the life of the lamp. The reflectivity of the Al film in the visible spectrum is about 88-90% so, for example, PAR 38 lamps incorporating Al films are able to convert about 70% of the light emitted from the lamp filament tube to luminous output. In particular, conventional manufacturing methods for assembling lamps with aluminum films incorporate several high temperature processes, including pre-heating, tubulating, aluminizing, brazing, and sealing. When preheating, the reflector is exposed to heat of about seven hundred and thirty-five degrees centigrade (735° C.), and then tubulating includes welding ferrules and an exhaust tube to a base of the reflector. The reflector is then aluminized to provide the aluminum coating. Next, the reflector is brazed, which involves welding the light source to the ferrules. A transparent cover lens is then sealed over the reflector opening. Typically, an open natural gas and oxygen flame is used to carry out many of the heating steps required for the process. The flame heats adjacent portions of the reflector to high temperatures. For example, when the reflector is sealed, the reflector and coating are subjected to a temperature of around 1000° C. in the seal region, and around 650° C. away from the seal.

Silver (Ag) films have a higher reflectivity than Al films and have been used in optics, electronics, and lighting applications. Due to new regulations requiring increased lamp light output efficiency, Ag film materials have become more popular with regard to the fabrication of lamp reflectors. For example, with regard to the PAR 38 lamp example described above, an Ag-coated reflector improves the lamp reflectance to about 95-98%, and such lamps typically convert about 80-85% of the light emitted from the lamp filament tube to a luminous output. This provides about a 15% lumen gain or improvement as compared to lamps having reflectors coated with Al film.

However, silver (Ag) films react with trace amounts of sulfur compounds in the atmosphere and thus a sulfide film can quickly form thereon to tarnish the surface of an unprotected Ag reflector (turning the surface brown or black), which degrades reflectivity. Thus, during fabrication of a lamp reflector having an Ag film layer, a topcoat layer or protection layer is typically sprayed onto or otherwise applied to cover the Ag film layer to protect it. Such topcoat layers have been made of various types of transparent substances including silica-base chemicals, and may contain sulfides, water, oxygen, and/or acids that penetrate through the topcoat to attack or tarnish the Ag film layer. A topcoat layer can also reduce Ag layer reflectivity and, in some cases due to stresses present in the topcoat layer, tear the Ag film layer away from the substrate. Thus, vacuum thin film coating processes have been utilized via a deposition chamber to first provide the Ag film layer on the substrate and then to deposit oxides or nitrides onto the Ag film layer as a topcoat layer or protection layer. In this manner, the topcoat layer can be made denser than an organic or inorganic topcoat layer, and the process can be designed to maintain the Ag film layer reflectivity and to control the topcoat layer stress to match that of the Ag film layer to prevent tearing. However, such vacuum thin film coating processes are time consuming and expensive, which increases the cost of a lamp having a reflector with an Ag film reflective layer fabricated in such manner.

Although Ag films may be prepared in a similar manner to aluminum films, evaporated Ag films are unstable at temperatures in excess of 200° C. In addition, Ag films are readily oxidized at the temperatures used for sealing Al lamps and thus the optical properties of the Ag films would be destroyed. Unprotected Ag films are thus unsuited to lamp manufacture by use of the same processes used to fabricate lamp reflectors having an Al film layer. Further, as mentioned above, Ag films exhibit poor chemical resistance to sulfide tarnishing, and thus the properties of the unprotected films are destroyed on exposure to the atmosphere.

Accordingly, the present inventors recognized that a need exists for an improved, dependable, and relatively inexpensive method for providing a lamp reflector having an Ag reflective layer in a manner that protects the Ag reflective layer from damage caused by gaseous substances.

### SUMMARY OF THE INVENTION

Presented are apparatus and methods for providing silver-based reflector that includes a hybrid protection layer. In some embodiments, a lamp reflector is formed by providing a substrate material in the shape of a reflector, thermally depositing an Ag reflective layer onto the an interior surface of the reflector having a sufficient thickness to reflect light, and thermally depositing an Al protective layer onto the Ag reflective layer to protect the Ag reflective layer from oxidation and sulfide formation. The Al protective layer has a thickness within the range of about 30 angstroms (Å) to about 100 Å.

In an advantageous embodiment, a lamp includes a housing in the shape of a reflector, a light source disposed within the housing, and a reflective coating on an interior surface of the reflector. The reflective coating includes a silver (Ag) reflective layer having a sufficient thickness to reflect light, and an aluminum (Al) protective layer deposited on the Ag reflective layer to protect the Ag reflective layer from oxidation and sulfide formation. The Al protective layer has a thickness within the range of about 30 angstroms (Å) to about 100 Å.

In a beneficial embodiment, a method of forming a reflector of a lamp includes providing a housing in the shape of a reflector, thermally depositing a silver (Ag) reflective layer onto an interior surface of the reflector of a sufficient thickness to reflect light, and thermally depositing an aluminum (Al) protective layer onto the Ag reflective layer to protect the Ag reflective layer from oxidation and sulfide formation. In this embodiment, the Al protective layer has a thickness within the range of about 30 angstroms (Å) to about 100 Å.

### BRIEF DESCRIPTION OF THE DRAWINGS

Aspects and/or features of the invention and many of their attendant benefits and/or advantages will become more readily apparent and appreciated by reference to the detailed description when taken in conjunction with the accompanying drawings, which drawings may not be drawn to scale.

FIG. 1 is a cross-sectional side view of an assembled lamp including a reflector having a silver reflective layer in accordance with some embodiments of the disclosure; and

FIG. 2 is an enlarged sectional view of a portion of a lamp light reflector having a multi-layer reflective coating according to some embodiments of the disclosure.

### DETAILED DESCRIPTION

In general, and for the purpose of introducing concepts of embodiments, described are apparatus and methods for providing a reflector having a silver (Ag) reflective surface layer for use with a lamp. In an embodiment, a substrate is provided that has the shape of a reflector and an interior surface. An implementation of the novel process includes depositing a silver (Ag) reflective layer onto the interior surface of the substrate, and then depositing an aluminum (Al) protective layer onto the Ag reflective layer. The Al protective layer has a thickness within the range of about thirty angstroms (30 Å) to about one-hundred angstroms (100 Å) (which is the same as 3 nanometers (nm) to 10 nm) and protects the Ag reflective layer from oxidation and sulfide formation. In some implementations, a dielectric coating layer is also deposited onto the Al protective layer, which dielectric coating layer may be composed of silicon oxide (SiO) or silicon dioxide (SiO₂).

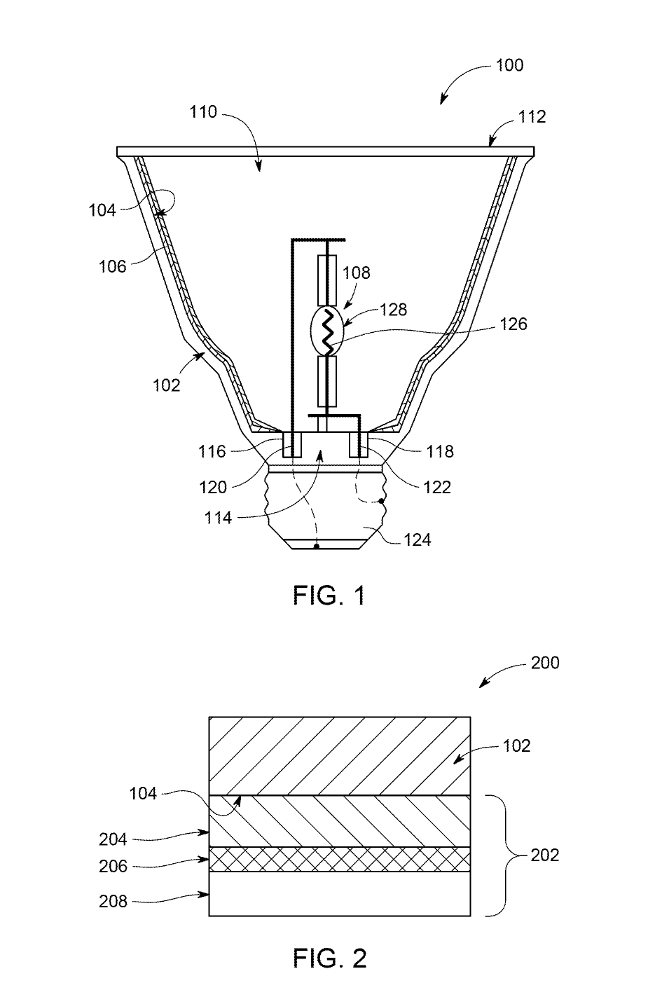

FIG. 1 is a cross-sectional side view of an assembled lamp 100 that includes a reflector having a silver reflective layer according to some embodiments. The lamp 100 includes a reflector housing 102 or substrate having an interior surface 104 that supports a multi-layer reflective coating 106. The interior surface 104 of the substrate 102 may have a parabolic or elliptical shape, such as that found in a PAR 30 or PAR 38 lamp (depicted in FIG. 1), or may be of any other suitable shape for directing light from a light source 108. An open end 110 of the substrate or housing 102 is covered by a lens 112. The lens 112 may be transparent to all light, and/or may include a filter to absorb and/or reflect the light from the light source 108, and/or may include an anti-reflection coating to enhance light transmission.

The reflector housing 102 also includes a closed end 114 having two pass-through channels 116 and 118 that permit electrical connections 120 and 122 to connect to the light source 108. The electrical connections 120 and 122 make electrical contact with a source of power (not shown) through a base 124 of the lamp 100 in addition to making electrical contact with the light source 108. In the example shown, the light source 108 includes a filament 126 (such as a tungsten filament) enclosed within an envelope 128, which may be formed from quartz, silica, or other suitable material. The envelope 128 may contain, for example, a halogen fill composed of krypton and methyl bromide.

Although the novel reflective coating described herein may suitably be used with a lamp 100 having a PAR 30 or PAR 38 reflector and a halogen light source 108, it should be understood that a variety of other types of light sources may replace the light source illustrated. For example, reflectors of other shapes and/or sizes may suitably be coated with the novel reflective coating. In addition, other types of light sources may suitably be utilized including, but not limited to, light emitting diodes (LEDs), laser diodes, conventional incandescent lamps, quartz metal halide lamps, and ceramic metal halide lamps, and the like, alone, or in combination and/or multiples thereof.

FIG. 2 is an enlarged sectional view 200 of a portion of a multi-layer light reflector for a lamp according to some embodiments. A reflector substrate 102 of the lamp has an inner surface 104 onto which the multi-layer light reflector 202 has been thermally deposited, for example, by utilizing a thermal evaporation process in a deposition chamber. The substrate 102 may be composed of plastic, fiberglass, metal, a composite material, or any other material suitable for forming a substrate or housing for a lamp reflector. The multi-layer reflective coating 202 includes a silver (Ag) reflective layer 204, a thin Aluminum (Al) protective layer 206, and a dielectric coating layer 208. In some embodiments, the Al protective layer 206 is in the range of about thirty angstroms (30 Å) to about one hundred angstroms (100 Å) and functions to protect the Ag reflective layer 204 from reacting with chemicals such as sulfides, water (moisture), and/or oxygen that can degrade the reflectivity of the AG reflective layer. In particular, the thin Al protective layer acts as a topcoat layer to protect the Ag reflective layer 204 from oxidation and sulfide formation during oxide film deposition as the extra oxygen reacts with the Al protective layer 206 to convert it to aluminum oxide, which is a transparent coating. The Al protective layer 206 is therefore substantially or fully transparent to light. In some implementations, a dielectric coating layer 208 is next deposited onto the Al protective layer 206. The dielectric coating layer 208 may include silicon oxide (SiO) or silicon dioxide (SiO₂), alumina (Al₂O₃), titanium dioxide (TiO₂) and/or other fluoride compounds such as magnesium fluoride (MgF₂) and the like.

Accordingly, the Al protective layer 206 is substantially transparent or fully transparent to light from a light source, and is of a suitable thickness to protect the Ag reflective layer 204 from tarnishing and from other types of processes that degrade reflectivity, both during assembly of the lamp 100 (such as during heat sealing of the lens to the housing) and also during the useful life of the lamp. Furthermore, the Al protective layer 206 is compatible with the Ag reflective layer with regard to coating and lamp making processes because little or no chemical reaction occurs between the Ag reflective layer and the Al protective layer, and because it is resistant to mechanical failure, both during the formation of the lamp and during its expected life. The Al protective layer 206 is also able to withstand thermal stresses, such as those that may occur during heat sealing of the lens, and stresses that may also occur during operation of the lamp.

In some embodiments, the Ag reflective layer 204 is formed entirely or predominantly from silver, such as pure silver or silver alloy. In some implementations, the level of impurity in the Ag reflective layer is less than 10%, while in others the impurity level is less than 1%. The Ag reflective layer 204 is of sufficient thickness such that light is reflected from its surface rather than transmitted therethrough, and in some embodiments, at least about 80% of the visible light which strikes the Ag reflective layer is reflected therefrom, and less than about 20% of the visible light is absorbed by or transmitted through the Ag reflective layer. In an embodiment, at least 90% of the light is reflected by the Ag reflective layer 204. Further, in some embodiments, the Ag reflective layer can be from about 0.1 to about 0.6 microns in thickness.

In some embodiments, the Al protective layer 206 is of sufficient thickness to protect the Ag reflective layer 204 both during lamp formation, and during its useful life. The Al protective layer may also be optimized to provide acceptable reflector performance. Reflector performance may be expressed in two ways: first, as Corrected Color Temperature (CCT) loss or gain (relative to the color temperature of the light source, such as a tungsten filament without a (silver) reflective surface and without a (silica) protective layer); and second, as percentage reflectance (the percentage of visible light striking the reflective coating which is reflected, rather than being absorbed or transmitted therethrough). Reflectance is related to lumen output (lumens per watt (LPW) of power supplied to the lamp, wherein the lumen output increases as reflectance is increased. Thus, in some implementations the Al protective layer 206 is approximately 3 nm thick or greater to ensure optimal reflector performance.

Thus, lamps incorporating a multi-layer reflector with an Ag reflective layer and Al protective layer in accordance with the embodiments described herein may advantageously provide improved reflectivity and performance as compared to lamps having only aluminum (Al) type reflectors.

The above descriptions and/or the accompanying drawings are not meant to imply a fixed order or sequence of steps for any process referred to herein; rather any process may be performed in any order that is practicable, including but not limited to simultaneous performance of steps indicated as sequential.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method of forming a reflector for a lamp comprising:
providing a substrate material in the shape of a reflector having an interior surface and an exterior surface;
thermally depositing a silver (Ag) reflective layer onto the interior surface of the substrate material, the Ag reflective layer of a sufficient thickness to reflect light; and
thermally depositing an aluminum (Al) protective layer onto the Ag reflective layer to protect the Ag reflective layer from oxidation and sulfide formation, wherein the Al protective layer has a thickness within the range of about 30 angstroms (Å) to about 100 Å.

2. The method of claim 1, further comprising depositing a dielectric coating layer onto the Al protective layer.

3. The method of claim 2, wherein the dielectric coating layer comprises one of silicon oxide (SiO) or silicon dioxide (SiO₂).

4. The method of claim 2, wherein the dielectric coating layer comprises one alumina (Al₂O₃) or titanium dioxide (TiO₂).

5. The method of claim 2, wherein the dielectric coating layer comprises magnesium fluoride (MgF₂).

6. The method of claim 1, wherein the Ag reflective layer and the Al protective layer are thermally deposited via a thermal evaporation process.

7. The method of claim 1, wherein the level of impurity of the Ag reflective layer is less than about ten percent (10%).

8. The method of claim 1, wherein the level of impurity of the Ag reflective layer is less than about one percent (1%).

9. The method of claim 1, wherein the Ag reflective layer is about 0.1 micron to about 0.6 microns thick.

10. The method of claim 1, wherein the Ag reflective layer reflects at least about 80% of the visible light impinging thereon.

11. The method of claim 1, wherein the Ag reflective layer reflects at least about 90% of the visible light impinging thereon.

12. A lamp comprising:
a housing in the shape of a reflector;
a light source disposed within the housing; and
a reflective coating on an interior surface of the reflector, the reflective coating comprising:
a silver (Ag) reflective layer having a sufficient thickness to reflect light; and
an aluminum (Al) protective layer deposited on the Ag reflective layer to protect the Ag reflective layer from oxidation and sulfide formation, wherein the Al protective layer has a thickness within the range of about 30 angstroms (Å) to about 100 Å.

13. The lamp of claim 12, further comprising a lens covering an opening of the housing.

14. The lamp of claim 12, wherein the reflective coating further comprises a dielectric coating layer on the Al protective layer.

15. The lamp of claim 12, wherein the light source comprises at least one of an incandescent light source, a ceramic metal halide light source, a light emitting diode (LED), a laser diode, a quartz metal halide light source.

16. A method of forming a reflector of a lamp comprising:
providing a housing in the shape of a reflector;
thermally depositing a silver (Ag) reflective layer onto an interior surface of the reflector of a sufficient thickness to reflect light; and
thermally depositing an aluminum (Al) protective layer onto the Ag reflective layer to protect the Ag reflective layer from oxidation and sulfide formation, wherein the Al protective layer has a thickness within the range of about 30 angstroms (Å) to about 100 Å.

18. The method of claim 16, further comprising thermally depositing a dielectric coating layer on the Al protective layer.

19. The method of claim 16, further comprising providing a light source within the housing.

20. The method of claim 19, further comprising heat sealing a lens to cover an opening of the housing.

21. The method of claim 19, wherein the light source comprises at least one of an incandescent light source, a ceramic metal halide light source, a light emitting diode (LED), a laser diode, a quartz metal halide light source.
